(19) United States
(12) Patent Application Publication
(10) Pub. No.: US 2024/0036800 A1
(43) Pub. Date: Feb. 1, 2024

(54) ELECTRONIC WHITEBOARD SYSTEM AND OPERATION METHOD THEREOF

(71) Applicant: Optoma Corporation, New Taipei City (TW)

(72) Inventors: Wen-Tai Wang, New Taipei City (TW); Ron-Fu Chen, New Taipei City (TW); Cheng-Kang Ho, New Taipei City (TW)

(73) Assignee: Optoma Corporation, New Taipei City (TW)

(21) Appl. No.: 17/874,243

(22) Filed: Jul. 26, 2022

(51) Int. Cl. G06F 3/14

(52) U.S. Cl. CPC G06F 3/1454

(57) ABSTRACT

An electronic whiteboard system and an operation method thereof are provided. The electronic whiteboard system includes a data processing device. The data processing device calculates an original message amount of an original object move message according to an object move operation on a cloud electronic whiteboard operated by one of the client devices. The data processing device simulates a grouping message amount of a grouping object move message according to the object move operation. The data processing device compares the original message amount and the grouping message amount to determine whether to generate the grouping object move message, and transmits the original object move message or the grouping object move message to other of the plurality of client devices.

### BACKGROUND

### Technical Field

The invention relates to a multi-user collaboration system, in particular, to an electronic whiteboard system and an operation method thereof.

### Description of Related Art

In general, multiple client devices of the electronic whiteboard system need to transmit a large amount of editing information to each other, so the amount of data transmitted by the electronic whiteboard system is too large, which affects the cost of system setup and causes communication delays. Especially, when a user selects one or more objects and moves the one or more objects simultaneously on the cloud electronic whiteboard to perform an object move operation, the electronic whiteboard system have to transmit multiple object move messages to the multiple client devices, so as to update the editing result of the electronic whiteboard system. Therefore, how to make the electronic whiteboard system to achieve efficient data transmission is one of the important issues in this field.

### SUMMARY

The invention is directed to an electronic whiteboard system and an operation method thereof, which may effectively reduce the amount of data transmission.

Other objects and advantages of the invention may be further illustrated by the technical features broadly embodied and described as follows.

In order to achieve one or a portion of or all of the objects or other objects, an embodiment of the invention provides an electronic whiteboard system. The electronic whiteboard system includes a data processing device. The data processing device is coupled to multiple client devices. The data processing device is configured to calculate an original message amount of an original object move message according to an object move operation on a cloud electronic whiteboard operated by one of the client devices. The data processing device is configured to simulate a grouping message amount of a grouping object move message according to the object move operation. The data processing device is configured to compare the original message amount and the grouping message amount to determine whether to generate the grouping object move message, and the data processing device is configured to transmit the original object move message or the grouping object move message to other of the client devices.

In the embodiment of the invention, when the data processing device determines that the grouping message amount is less than the original message amount, the data processing device is configured to transmit the grouping object move message to the other of the client devices.

In the embodiment of the invention, the grouping object move message includes a grouping identification message and at least one grouping move message.

In the embodiment of the invention, the grouping identification message has a first character amount, and one of the at least one grouping move message has a second character amount. The data processing device is configured to multiply the second character amount by an object shift amount and add the first character amount to obtain the grouping message amount.

In the embodiment of the invention, the object shift amount is amount of movement of pixel coordinates of the object move operation.

In the embodiment of the invention, the data processing device is configured to transmit the grouping identification message to the other of the client devices, and then transmit the at least one grouping move message to the other of the client devices.

In the embodiment of the invention, when the data processing device determines that the grouping message amount is more than or equal to the original message amount, the data processing device is configured to transmit the original object move message to the other of the client devices.

In the embodiment of the invention, the data processing device is configured to previously confirm multiple moved objects in the object move operation to calculate the original message amount according to number of moved objects and an object shift amount.

In the embodiment of the invention, the data processing device is configured to multiply an original character amount of a socket message by the number of moved objects and multiply the object shift amount to obtain the original message amount.

In the embodiment of the invention, the object shift amount is amount of movement of pixel coordinates of the object move operation.

In order to achieve one or a portion of or all of the objects or other objects, an embodiment of the invention provides an operation method of an electronic whiteboard system. The operation method includes the following steps: calculating an original message amount of an original object move message according to an object move operation on a cloud electronic whiteboard operated by one of multiple client devices, simulating a grouping message amount of a grouping object move message according to the object move operation; and comparing the original message amount and the grouping message amount to determine whether to generate the grouping object move message, and transmitting the original object move message or the grouping object move message to other of the client devices.

In the embodiment of the invention, the operation method further includes the following step: when the grouping message amount is less than the original message amount, transmitting the grouping object move message to the other of the client devices.

In the embodiment of the invention, the grouping object move message includes a grouping identification message and at least one grouping move message.

In the embodiment of the invention, the grouping identification message has a first character amount, and one of the at least one grouping move message has a second character amount. The step of simulating the grouping message amount of the grouping object move message according to the object move operation includes: multiplying the second character amount by an object shift amount and adding the first character amount to obtain the grouping message amount.

In the embodiment of the invention, the object shift amount is amount of movement of pixel coordinates of the object move operation.

In the embodiment of the invention, the step of transmitting the grouping object move message to the other of the client devices includes: first transmitting the grouping identification message to the other of the client devices, and then transmitting the at least one grouping move message to the other of the client devices.

In the embodiment of the invention, the operation method further includes the following step: when the grouping message amount is more than or equal to the original message amount, transmitting the original object move message to the other of the client devices.

In the embodiment of the invention, the step of calculating the original message amount of the original object move message according to the object move operation includes: previously confirming multiple moved objects in the object move operation to calculate the original message amount according to number of moved objects and an object shift amount.

In the embodiment of the invention, the step of calculating the original message amount of the original object move message according to the object move operation includes: multiplying an original character amount of a socket message by the number of moved objects and multiplying the object shift amount to obtain the original message amount.

In the embodiment of the invention, the object shift amount is amount of movement of pixel coordinates of the object move operation.

Based on the above description, the electronic whiteboard system and an operation method thereof of the invention may automatically simulate the grouping message amount of the grouping object move message according to the object move operation, and compare the original message amount of the original object move message and the grouping message amount of the grouping object move message to determine to transmit the object move message with smaller amount of data to the client devices.

To make the aforementioned more comprehensible, several embodiments accompanied with drawings are described in detail as follows.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of information transmission of an electronic whiteboard system according to an embodiment of the invention.

FIG. 2 is a schematic diagram of information transmission of a terminal device according to an embodiment of the invention.

FIG. 3 is a flowchart of an operation method of an electronic whiteboard system according to an embodiment of the invention.

FIG. 4 is a line graph of the grouping message amount and the original message amount according to an embodiment of the invention.

FIG. 5 is a line graph of the grouping message amount and the original message amount according to an embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The above and other technical contents, features, and effects of the invention will be clearly presented in the following detailed description of a preferred embodiment with reference to the accompanying drawings. Directional terminology, such as “top,” “bottom,” “left,” “right,” “front,” “back,” etc., mentioned in the following embodiments is used with reference to the orientation of the Figure(s) being described and are not intended to be limiting of the invention.

In order to make the content of the invention more comprehensible, the following embodiments are specifically cited as examples on which the invention may indeed be implemented. In addition, wherever possible, elements/components/steps with the same reference numbers in the drawings and embodiments represent the same or similar components.

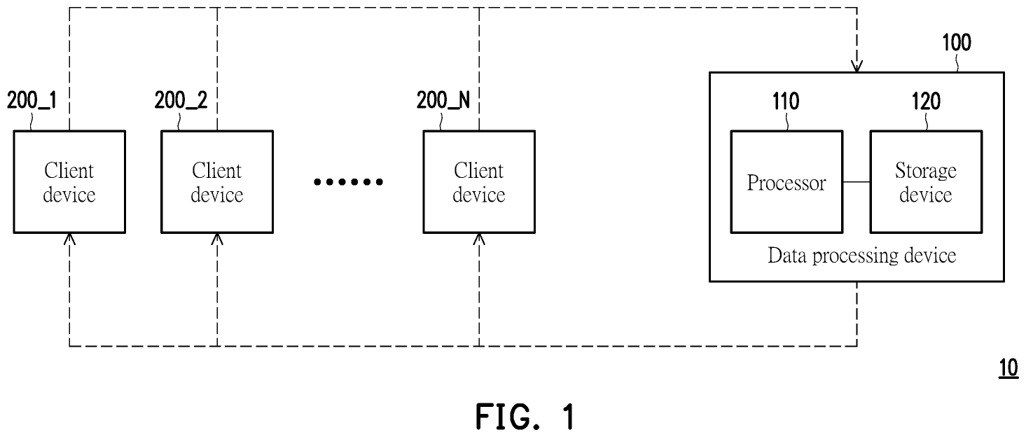

FIG. 1 is a schematic diagram of information transmission of an electronic whiteboard system according to an embodiment of the invention. Referring to FIG. 1, the electronic whiteboard system 10 includes a data processing device 100 and multiple client devices 200_1 to 200_N, where N is a positive integer. The data processing device 100 is coupled to the client devices 200_1 to 200_N. In the embodiment of the invention, through an Internet, the client devices 200_1 to 200_N and the data processing device 100 may perform communication connection to transfer the information. The data processing device 100 may be disposed in the company capable of providing the service, and the data processing device 100 may be, for example, a cloud server. The data processing device 100 is configured to provide a cloud electronic whiteboard function. The cloud electronic whiteboard means that the users may display the image and related application tools (such as brushes, colors, etc.) like a physical electronic whiteboard on the display devices of the client devices 200_1 to 200_N through the web application, and the users may perform actions such as drawing, moving objects or sharing files on the image of the display devices. The users may jointly edit on a common virtual whiteboard, and the users may view the same image of the cloud electronic whiteboard through the display devices of the client devices 200_1 to 200_N.

In the embodiment of the invention, the client devices 200_1 to 200_N may be operated by multiple users, respectively. The client devices 200_1 to 200_N may be, for example, electronic whiteboards with network functions, and each of the client device 200_1 to 200_N may have a processor and a storage device, so that the web application may be stored in the storage device, and the processor of each of the client devices 200_1 to 200_N may execute the web application. Multiple users may respectively execute, for example, a web application program on the client devices 200_1 to 200_N to perform related editing operations on the cloud electronic whiteboard. The data processing device 100 may be configured as a collaboration hub connecting to multiple electronic whiteboards (client devices 200_1 to 200_N) to collect multiple edit information provided by the multiple users performing collaborative editing of the cloud electronic whiteboard on the client devices 200_1 to 200_N respectively. The data processing device 100 may process the edit information, so that the web application programs respectively executed by the client devices 200_1 to 200_N may display the collaborative editing result of the cloud electronic whiteboard.

In the embodiment of the invention, each of the client devices 200_1 to 200_N may have the processor and the storage device, and the processor is coupled to the storage device. The data processing apparatus 100 includes a processor 110 and a storage device 120. The processor 110 is coupled to the storage device 120. The processor and the storage device of each of the client devices 200_1 to 200_N and the processor 110 and the storage device 120 of the data processing device 100 may configured as the same type of devices, and described below. The processor 110 may include, for example, a central processing unit (CPU) having an image data processing function, or other programmable general-purpose or special-purpose microprocessors, an image processing units (IPU), a graphics processing unit (GPU), a digital signal processor (DSP), an application specific integrated circuits (ASIC), a programmable logic device (PLD), other similar arithmetic circuits, or a combination of these circuits. The storage device 120 may include, for example, a non-volatile memory. The storage device 120 may store the programs and algorithms of the data computing module and the related electronic whiteboard system for the processor 110 to read and execute them, so as to realize the related operations, processes and functions of the cloud electronic whiteboard of the present invention.

In the embodiment of the invention, the data processing device 100 may further include a communication interface (or a data transmission module) (not shown in figure), and the data processing device 100 may be connected to the Internet or other network systems, for example, through the communication interface. In one embodiment of the invention, the data processing device 100 may further include a signal conversion module (not shown in figure), and the signal conversion module may be configured to receive and convert user's operation signal generated by editing on the cloud electronic whiteboard.

In the embodiment of the invention, the client devices 200_1 to 200_N may be, for example, an electronic whiteboard with networking capability, a personal computer (PC), a tablet computer, a smart phone or similar electronic device, respectively, and may also include, for example, a processor, a storage device, a display device, an input interface and a communication interface. The communication interface is an interface capable of connecting the Internet, such as a circuit or a device connecting to the Internet by wireless (Wi-Fi device) or cable. The processor and the storage device of each of the client devices 200_1 to 200_N and the data processing device 100 may configured as the same type of devices. The respective displays of the client devices 200_1 to 200_N may synchronously display the same editing result of the cloud electronic whiteboard. The respective input interfaces of the client devices 200_1 to 200_N may receive editing operation to generate corresponding edit information. The respective communication interfaces of the client devices 200_1 to 200_N may be connected to the data processing device 100 through the Internet, so as to transmit and receive the edit information of the relevant cloud electronic whiteboard. In the embodiment of the invention, the electronic whiteboard system 10 may be applied to various electronic whiteboard operation situations such as a teaching situation, a speech situation or a group discussion situation. Multiple users may operate the client devices 200_1 to 200_N to edit the same or different objects in the cloud electronic whiteboard at the same time or at different times. Besides, the objects may be, for example, patterns, lines, characters, etc. displayed on the cloud electronic whiteboard, which are not limited by the present invention.

In the embodiment of the invention, the edit information includes an object move message, and the object move message means that the user selects one or more objects and moves the one or more objects simultaneously on the cloud electronic whiteboard to perform an object move operation through one of the client devices 200_1 to 200_N, for example, by dragging a mouse or using a stylus pen. In this regards, the one of the client devices 200_1 to 200_N may transmit the corresponding object move message to the data processing device 100, and the data processing device 100 may generate one or more corresponding object move messages for transmitting to the other client devices, so that all client devices 200_1 to 200_N may synchronously display the same cloud whiteboard object movement result.

In the embodiment of the invention, in the process of transmitting multiple object motion information (from the data processing device 100 to the other client devices), in order to ensure the minimum amount of data transmission, the data processing device 100 may automatically simulate a grouping message amount of a grouping object move message in advance according to the object move operation, and compare an original message amount of the original object move message and the grouping message amount of the grouping object move message to determine to transmit the object move message with smaller amount of data to the other client devices.

In the embodiment of the invention, the original object move message may include the data size and quantity of the object itself (eg, corresponding to the plurality of the following socket messages) and its pixel coordinate displacement information to be moved. The grouping object move message may include information of the data size of the grouped object itself (eg, the following grouping identification message) and its pixel coordinate displacement information to be moved (eg, the following grouping move message).

In addition, the above-mentioned object move message may also carry out data encoding and data decoding through the data processing device 100 and the client devices 200_1 to 200_N during the message transmission process, so as to realize an effective message transmission operation, and the present invention is not limited thereto.

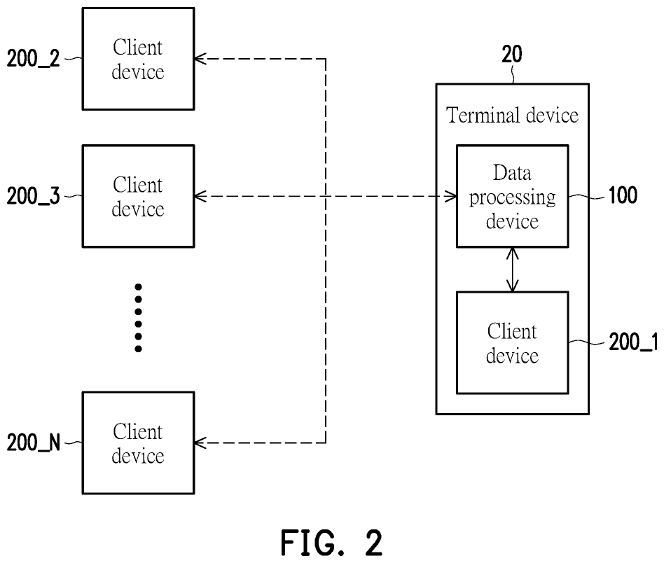

FIG. 2 is a schematic diagram of information transmission of a terminal device according to an embodiment of the invention. Referring to FIG. 2, different from the embodiment of FIG. 1, the data processing device 100 and the client device 200_1 may be integrated into a terminal device 20. The client device 200_1 may be coupled to the data processing device 100 by wired manner (e.g. internal wiring of the terminal device 20). The client devices 200_2 to 200_N may be coupled to the data processing device 100, for example, by the Internet or other wireless manners. In the embodiment of the invention, the terminal device 20 may be, for example, an electronic whiteboard with networking function, a personal computer (PC), a tablet computer, a smart phone or similar electronic device. The terminal device 20 may be a host device for providing the cloud electronic whiteboard function and data computer function, and the client devices 200_2 to 200_N may be slave devices for providing the cloud electronic whiteboard function by connecting to the terminal device 20.

For example, the user may operate the data processing device 100 of the terminal device 20 to enable a cloud software platform to start the cloud electronic whiteboard function by operated the client device 200_1, while other users may operate the client devices 200_2 to 200_N to connect to the terminal device 20 and to join the cloud electronic whiteboard, so as to perform the collaborative editing function of the cloud electronic whiteboard.

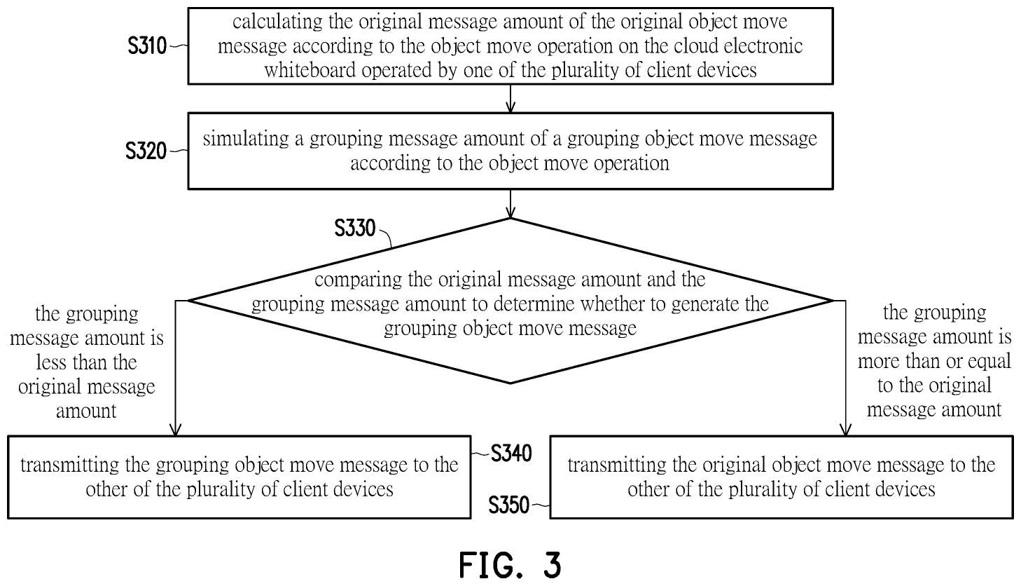

FIG. 3 is a flowchart of an operation method of an electronic whiteboard system according to an embodiment of the invention. Referring to FIG. 1 and FIG. 3, the data processing device 100 may execute the following steps to effectively reduce the amount of data transmission. The operation method of the following embodiment may also applicable to the embodiment of FIG. 2. In the embodiment of the invention, when a user operates one of the client devices 200_1 to 200_N, for example, the client device 200_1, to select and move one or more object displayed on the cloud electronic whiteboard, the client device 200_1 may transmit an original object move message to the data processing device 100. In step S310, the processor 110 of the data processing device 100 may calculate the original message amount of the original object move message according to the object move operation on the cloud electronic whiteboard operated by the client device 200_1.

In one embodiment of the invention, the data processing device 100 may previously confirm multiple moved objects in the object move operation to calculate the original message amount according to number of moved objects and an object shift amount. The data processing device 100 may multiply an original character amount of a socket message by the number of moved objects and multiply the object shift amount to obtain the original message amount. The original object move message may include multiple the socket messages according to the number of moved objects and the object shift amount.

In one embodiment of the invention, the original character amount of the socket message may previously storage in the storage device 120 by a lookup table, but the present invention is not limited thereto. The object shift amount may be an amount of movement of pixel coordinates of the object move operation displayed on the cloud electronic whiteboard. Taking the data format of JavaScript Object Notation (JSON) as an example, the original character amount of the socket message may be 570 bytes, the number of moved objects may be 10, and the object shift amount may be 12 pixels. Thus, the original message amount may equal to 68400 bytes (=570*10*12). The above numerical values are all exemplary descriptions, and the present invention is not limited thereto.

In step S320, the processor 110 of the data processing device 100 may simulate a grouping message amount of a grouping object move message of the object move operation. In one embodiment of the invention, the grouping object move message may include a grouping identification message and at least one grouping move message. The grouping identification message is configured to declare all objects to be moved (the one currently selected by the user). In other words, regardless of the number of objects, no matter the number of objects is 10, 20, 100 or 1000, the message amount of the grouping identification message is constant. The grouped movement message is configured to declare movement information of a one-pixel movement amount of the object movement operation. In one embodiment of the invention, the grouping identification message has a first character amount, and one of the at least one grouping move message has a second character amount. The data processing device 100 may multiply the second character amount by the object shift amount and add the first character amount to obtain the grouping message amount. Continuing the above example, the first character amount may be 1200 bytes, and the second character amount may be 470 bytes. Thus, the grouping message amount may equal to 6840 bytes (=(470*12)+1200).

In step S330, the processor 110 of the data processing device 100 may compare the original message amount and the grouping message amount to determine whether to specifically generate the grouping object move message. When the processor 110 of the data processing device 100 determines that the grouping message amount is less than the original message amount, the data processing device 100 executes the step S340. Continuing the above example, the processor 110 of the data processing device 100 may determine the grouping message amount (6840 bytes) is less than the original message amount (68400 bytes). In step S340, the data processing device 100 may transmit the grouping object move message to the other of the client devices 200_2 to 200_N. Therefore, the processor 110 of the data processing device 100 may automatically encode to generate the grouping object move message including the grouping identification message and the at least one grouping move message. In one embodiment of the invention, the data processing device 100 may first transmit the grouping identification message to the other of the client devices 200_2 to 200_N, and then transmit the at least one grouping move message to the other of the client devices 200_2 to 200_N according to the number of pixels corresponding to the moving distance.

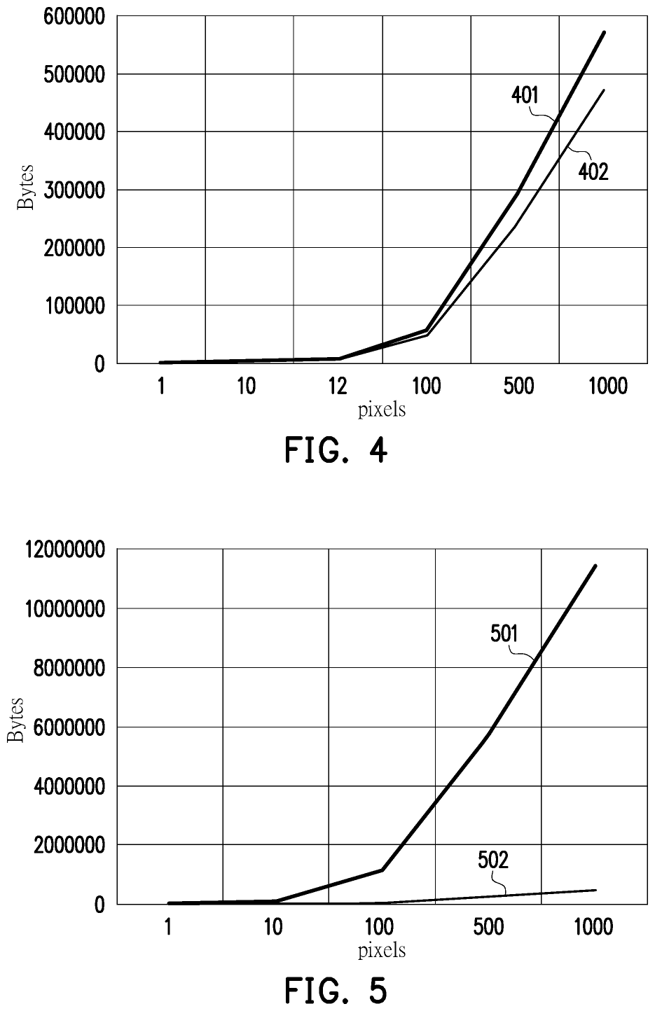

FIG. 4 is a line graph of the grouping message amount and the original message amount according to an embodiment of the invention. Table 1 is a table of the grouping message amount and the original message amount according to an embodiment of the invention. Please refer to FIG. 4 and Table 1 at the same time, FIG. 4 is a schematic diagram of the numerical change trend of Table 1, and the line graph of FIG. 4 is represented as the result of the message amount corresponding to 1 moved object and different movement amounts. The horizontal axis of FIG. 4 is represented as the different movement amounts (pixels), and the vertical axis of FIG. 4 is represented as the different message amounts (bytes). The line 401 shown in FIG. 4 corresponds to the change of the original message amount, and the line 402 shown in FIG. 4 corresponds to the change of the grouping message amount. In the embodiment of the invention, the original character amount of the socket message of a circular object is, for example, 570 characters. Referring to the line 401 and Table 1, the original message amount of the 1 moved object which is moved 12 pixels may equal to 6840 bytes (=570*1*12). Referring to the line 402 and Table 1, the grouping message amount which is moved 12 pixels may equal to 6840 bytes (=(470*12)+1200). Referring to the line 401 and Table 1, the original message amount of the 1 moved object which is moved 13 pixels may equal to 7410 bytes (=570*1*13). Referring to the line 402 and Table 1, the grouping message amount which is moved 13 pixels may equal to 7310 bytes (=(470*13)+1200). Therefore, when the circular object is moved by more than 12 pixel displacement points, that is, the object shift amount of the circular object is more than 12 pixels, the grouping message amount of the grouping object move message may be less than the original message amount of the original object move message.

TABLE 1

| Object shift | Original message amount | | Grouping message amount | |
|---|---|---|---|---|
| amount (pixel) | (1 moved object) | | (1 moved object) | |
| 1 | 570 | (bytes) | 1,670 | (bytes) |
| 10 | 5,700 | (bytes) | 5,900 | (bytes) |
| 12 | 6,840 | (bytes) | 6,840 | (bytes) |
| 100 | 57,000 | (bytes) | 48,200 | (bytes) |
| 500 | 285,000 | (bytes) | 236,200 | (bytes) |
| 1000 | 570,000 | (bytes) | 471,200 | (bytes) |

FIG. 5 is a line graph of the grouping message amount and the original message amount according to an embodiment of the invention. Table 2 is a table of the grouping message amount and the original message amount according to an embodiment of the invention. Please refer to FIG. 5 and Table 2 at the same time, FIG. 5 is a schematic diagram of numerical change trend of Table 2, and the line graph of FIG. 5 is represented as the result of the message amount corresponding to 20 moved objects and different movement amounts. The horizontal axis of FIG. 5 is represented as the different movement amounts (pixels), and the vertical axis of FIG. 5 is represented as the different message amounts (bytes). The line 501 shown in FIG. 5 corresponds to the change of the original message amount, and the line 502 shown in FIG. 5 corresponds to the change of the grouping message amount. Continuing the above example, when the number of moved objects is, for example, twenty, and the object shift amount of the twenty objects is, for example, 1000 pixels. Referring to the line 501 and Table 2, the original message amount may equal to 11,400,000 bytes (=570*20*1000). Referring to the line 502 and Table 2, the grouping message amount of the grouping object move message may equal to 471,200 bytes (=1200+470*1000). That is, the grouping message amount is 4.13% of the original message amount (=(1200+470*1000)/(570*20*1000)=471,200/11,400,000). In the embodiment of the invention, no matter the number of objects is 10, 20, 100 or 1000, the message amount of the grouping identification message is constant, which means the message amount of the grouping identification message may not be multiplied, and the grouping message amount is only affected by the object shift amount. Therefore, compare to the original message amount of the original object move message affected by the socket message by the number of moved objects and the object shift amount, the grouping message amount may be less than the original message amount when the number of moved objects or the object shift amount is more than a certain value.

TABLE 2

| Object shift | Original message amount | | Grouping message amount | |
|---|---|---|---|---|
| amount (pixel) | (20 moved objects) | | (20 moved objects) | |
| 1 | 11,400 | (bytes) | 1,670 | (bytes) |
| 10 | 114,000 | (bytes) | 5,900 | (bytes) |
| 100 | 1,140,000 | (bytes) | 48,200 | (bytes) |
| 500 | 5,700,000 | (bytes) | 236,200 | (bytes) |
| 1000 | 11,400,000 | (bytes) | 471,200 | (bytes) |

However, in other embodiments of the invention, when the processor 110 of the data processing device 100 determines that the grouping message amount is more than or equal to the original message amount, the data processing device 100 executes the step S350. In step S350, the data processing device 100 may transmit the original object move message to the other of the client devices 200_2 to 200_N. For example, the original character amount of the socket message may be 570 bytes, the number of moved objects may be 1, and the object shift amount may be 10 pixels. Thus, the original message amount of the original object move message may equal to 5700 bytes (=570*1*10). Moreover, the first character amount may be 1200 bytes, and the second character amount may be 470 bytes. Thus, the grouping message amount of the grouping object move message may equal to 5900 bytes (=(470*10)+1200). Thus, the data processing device 100 may determine that the grouping message amount (5900 bytes) is more than the original message amount (5700 bytes).

Therefore, the data processing device 100 is capable of determining which one of the grouping message amount of the grouping object move message and the original message amount of the original object move message has a smaller data amount, and the data processing device 100 transmits the object move message having the smaller data amount to the other of the client devices 200_2 to 200_N.

In summary, the electronic whiteboard system and the operation method thereof of the invention may automatically calculate the message amount to determine the object move message having the smaller data amount for transmitting between the client devices. Therefore, the electronic whiteboard system and the operation method thereof of the invention may dynamically adjust the data transmission format of the object move message, so as to effectively reduce the amount of data transmission between the client devices.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents. Moreover, any embodiment of or the claims of the invention is unnecessary to implement all advantages or features disclosed by the invention. In addition, the abstract and the name of the invention are only configured to assist patent searching, and are not configured to limit a claim range of the invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An electronic whiteboard system, comprising:
a data processing device, coupled to a plurality of client devices,
wherein the data processing device is configured to calculate an original message amount of an original object move message according to an object move operation on a cloud electronic whiteboard operated by one of a plurality of client devices, and the data processing device is configured to simulate a grouping message amount of a grouping object move message according to the object move operation,
wherein the data processing device is configured to compare the original message amount and the grouping message amount to determine whether to generate the grouping object move message, and the data processing device is configured to transmit the original object move message or the grouping object move message to other of the plurality of client devices.

2. The electronic whiteboard system according to the claim 1, wherein when the data processing device determines that the grouping message amount is less than the original message amount, the data processing device is configured to transmit the grouping object move message to the other of the plurality of client devices.

3. The electronic whiteboard system according to the claim 1, wherein the grouping object move message includes a grouping identification message and at least one grouping move message.

4. The electronic whiteboard system according to the claim 3, wherein the grouping identification message has a first character amount, and one of the at least one grouping move message has a second character amount,
wherein the data processing device is configured to multiply the second character amount by an object shift amount and add the first character amount to obtain the grouping message amount.

5. The electronic whiteboard system according to the claim 4, wherein the object shift amount is amount of movement of pixel coordinates of the object move operation.

6. The electronic whiteboard system according to the claim 3, wherein the data processing device is configured to transmit the grouping identification message to the other of the plurality of client devices, and then transmit the at least one grouping move message to the other of the plurality of client devices.

7. The electronic whiteboard system according to the claim 1, wherein when the data processing device determines that the grouping message amount is more than or equal to the original message amount, the data processing device is configured to transmit the original object move message to the other of the plurality of client devices.

8. The electronic whiteboard system according to the claim 1, wherein the data processing device is configured to previously confirm a plurality of moved objects in the object move operation to calculate the original message amount according to number of moved objects and an object shift amount.

9. The electronic whiteboard system according to the claim 8, wherein the data processing device is configured to multiply an original character amount of a socket message by the number of moved objects and multiply the object shift amount to obtain the original message amount.

10. The electronic whiteboard system according to the claim 9, wherein the object shift amount is amount of movement of pixel coordinates of the object move operation.

11. An operation method of an electronic whiteboard system, comprising:
calculating an original message amount of an original object move message according to an object move operation on a cloud electronic whiteboard operated by one of a plurality of client devices;
simulating a grouping message amount of a grouping object move message according to the object move operation; and
comparing the original message amount and the grouping message amount to determine whether to generate the grouping object move message, and transmitting the original object move message or the grouping object move message to other of the plurality of client devices.

12. The operation method according to claim 11, further comprising:
when the grouping message amount is less than the original message amount, transmitting the grouping object move message to the other of the plurality of client devices.

13. The operation method according to claim 11, wherein the grouping object move message includes a grouping identification message and at least one grouping move message.

14. The operation method according to claim 13, wherein the grouping identification message has a first character amount, and one of the at least one grouping move message has a second character amount,
wherein the step of simulating the grouping message amount of the grouping object move message according to the object move operation comprises:
multiplying the second character amount by an object shift amount and adding the first character amount to obtain the grouping message amount.

15. The operation method according to claim 14, wherein the object shift amount is amount of movement of pixel coordinates of the object move operation.

16. The operation method according to claim 13, wherein the step of transmitting the grouping object move message to the other of the plurality of client devices comprises:
first transmitting the grouping identification message to the other of the plurality of client devices, and then transmitting the at least one grouping move message to the other of the plurality of client devices.

17. The operation method according to claim 11, further comprising:
when the grouping message amount is more than or equal to the original message amount, transmitting the original object move message to the other of the plurality of client devices.

18. The operation method according to claim 11, wherein the step of calculating the original message amount of the original object move message according to the object move operation comprises:
previously confirming a plurality of moved objects in the object move operation to calculate the original message amount according to number of moved objects and an object shift amount.

19. The operation method according to claim 18, wherein the step of calculating the original message amount of the original object move message according to the object move operation comprises:
multiplying an original character amount of a socket message by the number of moved objects and multiplying the object shift amount to obtain the original message amount.

20. The operation method according to claim 19, wherein the object shift amount is amount of movement of pixel coordinates of the object move operation.
